(19) United States
(12) Patent Application Publication
(10) Pub. No.: US 2025/0196168 A1
(43) Pub. Date: Jun. 19, 2025

(54) KINETIC WATER DELIVERY DEVICES

(71) Applicant: Kohler Co., Kohler, WI (US)

(72) Inventor: Pete Kajuch, Brookfield, WI (US)

(73) Assignee: Kohler Co., Kohler, WI (US)

(21) Appl. No.: 18/956,219

(22) Filed: Nov. 22, 2024

Related U.S. Application Data
(60) Provisional application No. 63/612,002, filed on Dec. 19, 2023.

(51) Int. Cl. B05B 3/04

(52) U.S. Cl. CPC B05B 3/0463

(57) ABSTRACT

A modular spray assembly for a spray head includes a stator having an inlet that can receive a flow of fluid. The modular spray assembly includes a cover coupled to the stator and having a first bearing disposed in the stator. The modular spray assembly includes an impeller rotatably coupled to the first bearing, in which the impeller includes a second bearing. The modular spray assembly includes a rotor rotatably coupled to the second bearing. The rotor can rotate eccentrically relative to the impeller by the second bearing. The impeller can rotate responsive to the inlet receiving the flow of fluid.

### CROSS-REFERENCE TO RELATED PATENT APPLICATIONS

This application claims the benefit of and priority to U.S. Provisional Patent Application No. 63/612,002, filed Dec. 19, 2023, incorporated herein by reference in its entirety.

### BACKGROUND

The present disclosure relates generally to a water delivery device. More specifically, the present disclosure relates to a modular spray assembly that can maintain spray performance at low inlet flow rates through the use of kinetic energy.

Generally speaking, as water conservation has become increasingly popular for reasons of environmental stewardship or necessary for reasons of droughts and water shortages, the market has demanded water delivery devices, such as shower spray heads and faucets, that can reduce water consumption by operating at low inlet flow rates (e.g., less than about 0.90 GPM). Most conventional shower spray heads, however, are unable to provide sufficient spray performance at these low inlet flow rates.

Thus, it would be advantageous to provide a modular spray assembly for use in one or more water delivery devices that addresses one or more of the aforementioned issues.

### SUMMARY

At least one embodiment of the present disclosure relates to a modular spray assembly for a spray head. The modular spray assembly includes a stator having an inlet that can receive a flow of fluid. The modular spray assembly includes a cover coupled to the stator and having a first bearing disposed in the stator. The modular spray assembly includes an impeller rotatably coupled to the first bearing, the impeller having a second bearing. The modular spray assembly includes a rotor rotatably coupled to the second bearing. The rotor can rotate eccentrically relative to the impeller by the second bearing. The impeller can rotate responsive to the inlet receiving the flow of fluid.

At least one embodiment of the present disclosure relates to a spray head. The spray head includes a modular spray assembly. The modular spray assembly includes a stator having an inlet that can receive a flow of fluid. The modular spray assembly includes a cover coupled to the stator and having a first bearing disposed in the stator. The modular spray assembly includes an impeller rotatably coupled to the first bearing, the impeller having a second bearing. The modular spray assembly includes a rotor rotatably coupled to the second bearing. The rotor can rotate eccentrically relative to the impeller by the second bearing. The impeller can rotate responsive to the inlet receiving the flow of fluid.

At least one embodiment of the present disclosure relates to a modular spray assembly for a spray head. The modular spray assembly includes a body having an inner undulating surface, an inlet that can receive a flow of fluid, and an outlet that can dispense the flow of fluid. The modular spray assembly includes a cover coupled to the body and having a first bearing disposed in the body and defining a first axis. The modular spray assembly includes an impeller rotatably coupled to the first bearing, the impeller having a second bearing defining a second axis that is offset from the first axis. The modular spray assembly includes a rotor rotatably coupled to the second bearing and having an outer undulating surface. The rotor can rotate about the second axis relative to the impeller by the second bearing. The impeller can rotate about the first axis responsive to the inlet receiving the flow of fluid. The rotation of the impeller can cause the outer undulating surface of the rotor to engage with the inner undulating surface of the body such that a portion of the rotor orbits relative to the outlet of the body.

At least one embodiment of the present disclosure relates to a modular spray assembly for a spray head. The modular spray assembly includes a stator, a rotor, an impeller, and a cover. The cover is coupled to the stator and includes a first bearing disposed in the stator. The impeller is rotatably coupled to the first bearing. The impeller includes a second bearing that is offset from the first bearing. The rotor is rotatably coupled to the impeller at the second bearing and is configured to rotate eccentrically relative to the impeller. The rotor includes an outer portion that rollingly engages with an inner surface of the stator to permit rotational movement of the rotor relative to the stator. The stator includes an inlet configured to direct a flow of fluid toward the impeller to rotate the impeller.

In some exemplary embodiments, the stator includes an opening that receives a portion of the rotor therein.

In some exemplary embodiments, the stator includes an inner surface having an undulating surface profile, and wherein the outer portion of the rotor has an undulating surface profile configured to rollingly engage with the inner surface of the stator.

In some exemplary embodiments, the impeller includes a plurality of vanes that are pitched to direct fluid received through the inlet of the stator toward the rotor.

In some exemplary embodiments, a seal is disposed within the stator to prevent fluid from leaking out of the stator as the rotor rotates.

### BRIEF DESCRIPTION OF THE DRAWINGS

FIG. 1 is an exploded view of a modular spray assembly, according to an exemplary implementation;

FIG. 2 is a cross-sectional view of the modular spray assembly of FIG. 1 cut along an axial direction, according to an exemplary implementation;

FIG. 3 is a cross-sectional view of the modular spray assembly of FIG. 1 cut along a radial direction, according to an exemplary implementation; and

FIG. 4 is a perspective view of the modular spray assembly of FIG. 1, according to an exemplary implementation.

### DETAILED DESCRIPTION

Generally, disclosed herein is a modular spray assembly that is configured to be used in one or more water delivery devices (e.g., spray heads, faucets, etc.) to provide improved spray performance at low inlet flow rates (e.g., less than about 0.90 GPM), as compared to conventional spray heads used in, for example, a shower environment. The modular spray assembly disclosed herein includes structural features and components that are designed to create a unique water spray pattern through rotary and orbital motion. This unique water spray pattern can provide the same or similar effect for a user as spray patterns from conventional spray heads that are based on higher inlet flow rates. In addition, by using rotary motion, the disclosed modular spray assembly can distribute water over a larger surface area and can help to prevent a numbing sensation that may occur as a result of a concentrated water jet impinging on one area of a user's body, as is the case with many conventional shower spray heads.

According to various implementations, the disclosed modular spray assembly includes a rotating nozzle head, such that streams of water exiting the device are separated into discrete droplets by forces that break the cohesion of the streams. These discrete droplets can be large enough in size and have enough forward velocity to provide an effective user experience, even at low inlet flow rates (e.g., less than about 0.90 GPM, etc.) by, for example, creating a massaging sensation for a user. In contrast, conventional shower spray heads are unable to provide a useful spray at these low inlet flow rates, as the resulting spray pattern would be too wide and too sparse to provide an effective user experience.

Referring generally to the FIGURES, disclosed herein is a modular spray assembly that can be coupled with, or installed within, various water or other fluid delivery devices including, but not limited to, spray heads, faucets, or other water delivery devices. The modular spray assembly includes a substantially cylindrical body (e.g., a stator) defining an internal cavity and a center axis. The body includes a first end having one or more inlets configured to receive water and deliver water to the internal cavity. The first end may also include a cover that can seal the body at the first end. The body includes a second end having an opening configured to receive one or more nozzles to expel the fluid received via the one or more inlets. The body may include an impeller rotatably coupled to the cover at the first end of the body. The impeller may be configured to rotate in one direction responsive to the inlets receiving water. The impeller may include an eccentric extension configured to define a bearing for a rotor. For example, the rotor may be rotatably coupled to the impeller by the bearing such that rotation of the impeller causes the rotor to rotate eccentrically about the center axis of the body.

The rotor may include an undulated outer surface configured to engage with a corresponding undulated inner surface of the body. The engagement between the outer surface of the rotor and the inner surface of the body may cause the rotor to rotate about a center axis of the rotor. The rotor may include a nozzle portion having one or more nozzles configured to expel the water within the body. The nozzle portion of the rotor may at least partially protrude through the opening of the body at the second end of the body. The nozzle portion of the rotor may be cylindrically shaped and may define a diameter that is lesser than the diameter of the opening of the body such that, as the rotor rotates about the center axis of the body and as the rotor rotates about the center axis of the rotor, the nozzle portion of the rotor can move along an inner perimeter of the opening of the body. With this configuration, the modular spray assembly may include nozzles that rotate about a first axis and about a second axis such that a massaging spray pattern is created. Further, the kinetic rotation of the impeller and the rotor may facilitate providing an outlet flow pattern using a relatively low inlet flow rate of water.

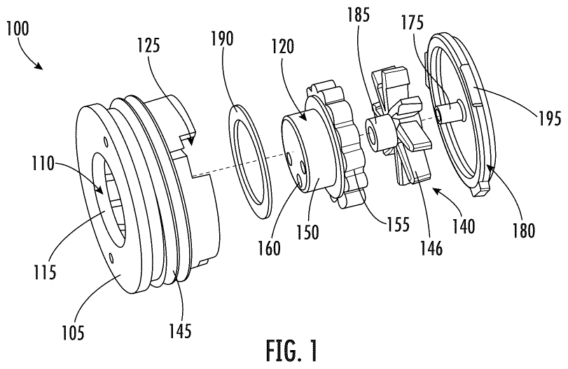

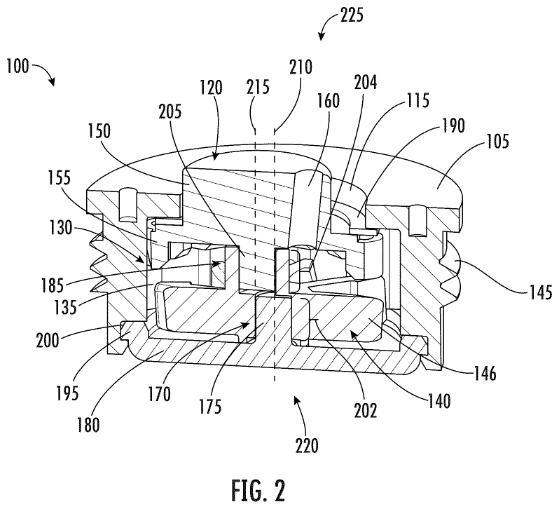

Referring to FIGS. 1 and 2, a modular spray assembly 100 is shown according to an exemplary implementation. The modular spray assembly 100 can be coupled to and/or used in various spray heads (e.g., showerheads, body sprayer, faucets, etc.) to modify a flow rate, flow pattern, or other characteristic of a flow of fluid through the spray head. For example, the stator 105 includes external attachment features, such as a plurality of outer threads 145, that facilitate detachably coupling the modular spray assembly 100 to, for example, a body of a water delivery device, such as a spray head or faucet. In other words, the modular spray assembly 100 is modular in that the modular spray assembly 100 of parts may pre-packaged and can be installed into a larger device such as a showerhead, body sprayer, or kitchen faucet.

The modular spray assembly 100 includes a stator 105. The stator 105 may include, for example, a housing or body for the modular spray assembly 100 extending between a first end 220 and a second end 225. For example, the stator 105 can at least partially enclose internal components of the modular spray assembly 100. The stator 105 may include a generally cylindrical shape having a central opening 110 at the second end 225 defined by a wall 115 of the stator 105. The central opening 110 can be shaped and/or sized to receive at least a portion of a rotor 120 of the modular spray assembly 100, as described in greater detail herein. In some implementations, one or more of the components of the modular spray assembly 100 may be made from a low friction material, such as acetal or other similar type of material or combinations of materials, to facilitate smooth rotation and/or movement of components, as described herein.

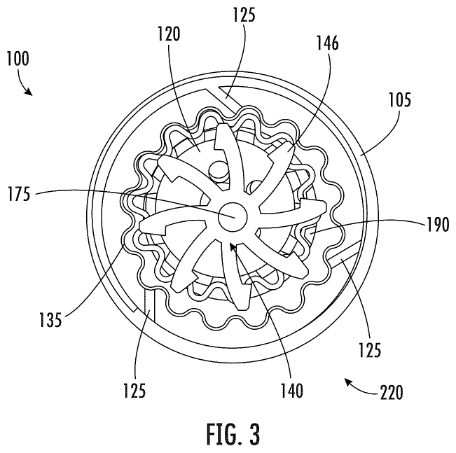

The stator 105 includes one or more inlets 125. The inlets 125 may be disposed, for example, circumferentially about the stator 105 at the first end 220 of the stator 105, as shown in FIG. 3. In some implementations, the inlets 125 are equally spaced circumferentially about a central axis (e.g., axis 210 shown in FIG. 2) of the stator 105. In some implementations, the inlets 125 may be randomly or unequally spaced circumferentially about the central axis 210 of the stator 105. The inlets 125 can receive fluid external to the stator 105 and direct fluid into an internal cavity 130 of the stator 105 defined by an inner wall 135 of the stator 105. The inlets 125 may be angled to direct fluid in a particular direction. For example, the inlets 125 may be angled such that fluid entering the internal cavity 130 through the inlets 125 enters at an angle relative to a radial direction of the stator 105 toward vanes 146 of an impeller 140, as described in greater detail herein.

Referring to FIGS. 1 and 2, the modular spray assembly 100 may include a seal 190, a rotor 120, an impeller 140, and a cover 180. Each of the seal 190, the rotor 120, the impeller 140, and the cover 180 are at least partially disposed within the internal cavity 130 defined by the inner wall 135 of the stator 105. The cover 180 may at least partially seal the internal cavity 130 formed by the inner wall 135 of the stator 105 such that fluid flowing into the internal cavity 130 from the inlets 125 does not exit through the first end 220 of the stator 105.

The cover 180 may include one or more tabs 195. The tabs 195 may extend circumferentially along a portion of a periphery of the cover 180 or along an entire periphery of the cover 180. The stator 105 may include one or more mating slots 200 capable of at least partially receiving the tabs 195 of the cover 180. For example, the mating slots 200 may be shaped and sized to receive the tabs 195 to fix the cover 180 relative to the stator 105 (e.g., such that the cover 180 does not rotate relative to the stator 105). In other words, the cover 180 is configured to couple to the stator 105 to retain the impeller 140, the rotor 120, and the seal 190 within the stator 105. In some implementations, the cover 180 may couple to the stator 105 using various additional or alternative types of attachment features, such as by clamps, snaps, an interference fit, a bayonet attachment, etc. In some implementations, the modular spray assembly 100 may not include a cover 180. For example, the first end 220 of the stator 105 may abut a surface of a water delivery device (e.g., a shower head, faucet, etc.) to function as a cover for the assembly 100.

The cover 180 and the impeller 140 define a first bearing 202 of the modular spray assembly 100. For example, in some implementations, the cover 180 may include a shaft 175 (e.g., protrusion) extending outwardly from an inner surface of the cover 180. The shaft 175 can at least partially receive a portion of the impeller 140 to define an axis of rotation for the impeller 140. For example, the shaft 175 can at least partially or entirely extend through a portion of the impeller 140, such as a first portion 170 (e.g., a first opening) of the impeller 140. The shaft 175 can include a substantially cylindrical shape and the first portion 170 (e.g., the first opening) of the impeller 140 can include a substantially cylindrical shape such that the impeller 140 can freely rotate about the shaft 175 at the first portion 170. In some implementations, the impeller 140 may include the shaft 175 and the cover 180 may include the first portion 170 or first opening to form the first bearing 202.

The first portion 170 (e.g., first opening) of the impeller 140 may be located at a center portion of the impeller 140. For example, a central axis extending through the first portion 170 of the impeller 140 may align with a central axis of the impeller 140. The central axis of the impeller 140 may align with the central axis 210 of the stator 105, as shown in FIG. 2. Therefore, each of the center axis of the impeller 140, the first portion 170 of the impeller 140, and the stator 105 may be referred to herein as axis 210.

The impeller 140 includes a plurality of vanes 146 (e.g., blades, fins, etc.) extending radially outward from the center of the impeller 140 (e.g., from the first portion 170). The vanes 146 may include a generally arcuate shape and may be angled or pitched to direct fluid received from the inlets 125 along an axial direction toward the rotor 120 and away from the cover 180 in response to rotation of the impeller 140 about the central axis of the first portion 170 (e.g., axis 210). For example, the impeller 140 may be disposed within the stator 105 adjacent to the one or more inlets 125 (e.g., at or near the first end 220) such that fluid flowing into the inlets 125 is directed towards the vanes of the impeller 140. The angle of the inlets 125 can facilitate causing the impeller 140 to spin in one direction (e.g., clockwise or counterclockwise) by applying a force to the vanes 146 of the impeller 140. Simultaneously, the angle of the vanes 146 of the impeller 140 can facilitate directing the fluid reflecting off the vanes 146 in a direction towards the rotor 120 and away from the cover 180. In some implementations, the angular pitch or rake of the vanes 146 can, advantageously, generate thrust toward the cover 180, which can reduce the forces transmitted to other moving parts in the assembly thereby reducing mechanical friction.

The impeller 140 and the rotor 120 define a second bearing 204 of the modular spray assembly 100. For example, in some implementations, the impeller 140 may include a second portion 185 extending from the impeller 140 (e.g., from a portion of the first portion 170, from a portion of one or more vanes 146, etc.). The second portion 185 may include a second opening. For example, in some implementations, the second portion 185 may include a second opening to receive a shaft 205 of the rotor 120 to define the second bearing 204. In some implementations, the second portion 185 of the impeller 140 may include the shaft 205 to protrude through an opening of the rotor 120 to define the second bearing 204.

The second bearing 204 may be configured such that the rotor 120 may freely rotate relative to the impeller 140. For example, the second portion 185 (e.g., second opening) of the impeller 140 may include a generally cylindrical shape with a center axis (e.g., axis 215) that is offset from the center axis of the first opening defined by the first portion 170 of the impeller 140 (e.g., axis 210). In other words, the second portion 185 is eccentric such that the center axis 215 of the second portion 185 of the impeller 140 is offset from both the center axis of the first portion 170 and from the center axis 210 of the impeller 140. With this configuration, rotation of the impeller 140 (e.g., responsive to a force of fluid applied to the vanes 146) causes the rotor 120 to both rotate about a center axis 215 of the rotor 120 and to orbit about a center axis 210 of the impeller 140 and the stator 105, as described in greater detail herein.

Referring to FIGS. 1-4, the rotor 120 includes a rotor nozzle 150 and a rotor base 155. The rotor nozzle 150 and the rotor base 155 may be integrally connected such that the rotor nozzle 150 and rotor base 155 form one, monolithic rotor 120. With this configuration, the rotor nozzle 150 motion path may be the same as the rotor base 155 path because they are single component. Having the rotor nozzle 150 and the rotor base 155 form one, continuous piece facilitates reducing the number of rotating mechanical parts that can be damaged by debris or other mineral deposits as compared to having the rotor nozzle 150 and rotor base 155 be separate components and facilitates reducing the number of parts formed during manufacturing.

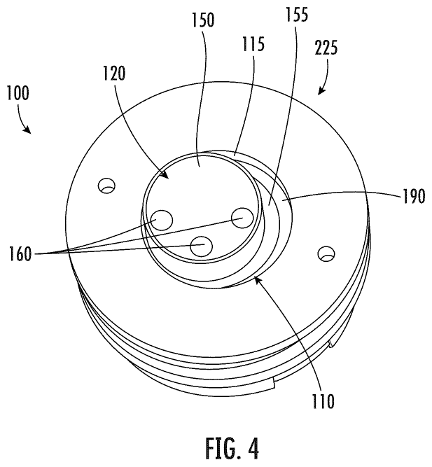

The rotor nozzle 150 may include a generally cylindrical shape. The rotor nozzle 150 may define a spray face of the modular spray assembly 100. For example, the rotor nozzle 150 may include one or more nozzles 160, as shown in FIG. 4. The one or more nozzles 160 are configured to receive fluid flowing through the stator 105 from the inlets 125 and spray fluid outside of the stator 105. For example, the rotor nozzle 150 is configured to at least partially protrude through the central opening 110 of the stator 105 adjacent the wall 115 such that the one or more nozzles 160 are exposed to an external portion of the stator 105. As shown in FIG. 2, the one or more nozzles 160 extend continuously through the rotor nozzle 150 to provide a fluid flow path from the internal cavity 130 of the stator 105 at the distal end of the rotor nozzle 150, as shown in FIG. 2.

In some implementations, the one or more nozzles 160 may be angled relative to the center axis 210 of the stator 105, as shown in FIG. 2. With this configuration, the nozzles 160 may spray fluid at an outward angle relative to the center axis 210 to define a wider spray range than if the nozzles 160 defined a pathway that is parallel with the center axis 210. In some implementations, the nozzles 160 may be circumferentially disposed along a portion of the rotor nozzle 150, as shown in FIG. 4. For example, the nozzles 160 may only be located within a first half of the spray face of the rotor nozzle 150. In some implementations, the nozzles 160 may be equally or substantially equally spaced circumferentially along the rotor nozzle 150 spray face. In some implementations, the nozzles 160 may be randomly or equally distributed about the rotor nozzles 150 spray face. The position of the nozzles 160 can be, for example, symmetric, clustered, or in another arrangement. Further, while three nozzles 160 are shown, the rotor 120 can include any amount of nozzles 160 based on the nozzle 160 diameter, the diameter of the rotor nozzle 150, the desired flow velocity, and/or the desired spray pattern.

An outer perimeter of the rotor base 155 includes an undulating surface (e.g., an outer undulating surface) having a plurality of alternating protrusions and recesses (e.g., similar to gear teeth). The inner wall 135 of the stator 105 includes a corresponding undulating surface (e.g., an inner undulating surface), as shown in FIG. 3, such that the outer profile of the rotor base 155 matches an inner profile of the stator 105. For example, the inner wall 135 includes a plurality of alternating protrusions and recesses forming an undulating surface profile that extends continuously about the center axis 210. The undulating surface profile of the inner wall 135, advantageously, provides an engagement surface for relative rotational movement of the rotor 120. For example, as the rotation of the impeller 140 causes the rotor 120 to rotate eccentrically relative to the impeller 140, the engagement between the undulating surfaces can simultaneously cause the rotor 120 to rotate about its own axis 215, which is offset from the center axis 210 of the stator 105 and the impeller 140. With this configuration, the outer portion of the rotor base 155 can rollingly engage with the inner wall 135 of the stator 105 and permit rotational movement of the rotor 120 relative to the stator 105, as shown in FIG. 3. In other words, the rotor base 155 can roll against the inner wall 135 via the undulating interface between the outer portion of the rotor base 155 and the inner wall 135 of the stator 105. Further, internal hydraulic pressure of water in the internal cavity 130 of the stator 105 can generate a thrust force on the rotor 120 to urge or bias the rotor 120 toward the central opening 110 of the stator 105.

The rotor base 155 includes a diameter that is larger than a diameter of the rotor nozzle 150 and the rotor nozzle 150 includes a diameter that is lesser than a diameter of the central opening 110 of the stator 105. For example, the diameter of the central opening 110 is about equal to the diameter of the rotor nozzle 150 plus two times the distance of the offset between the first center axis 210 and the second center axis 215. Therefore, the diameter of the central opening 110 is greater than the diameter of the rotor nozzle 150. With this configuration, the rotor 120 rotates about its own center axis 215 and also orbits about the first center axis 210 as the outer portion of the rotor nozzle 150 engages with (e.g., contacts) the wall 115 defined by the central opening 110 of the stator 105. In other words, the eccentric rotation of the rotor 120 relative to rotation of the impeller 140 causes the rotor nozzle 150 to move along the perimeter of the central opening 110 of the stator 105.

As the rotor nozzle 150 makes a rotation along the wall 115 of the central opening 110 of the stator 105, the larger diameter of the central opening 110 may create a crescent-shaped opening between the rotor base 155 and the wall 115 of the stator 105 at a side of the central opening 110 opposite where the rotor nozzle 150 is contacting the wall 115 of the central opening 110, as can be seen in FIG. 4. The seal 190 may be positioned over this crescent-shaped opening to facilitate preventing fluid (e.g., water) from leaking through the crescent-shaped opening of the stator 105. For example, the seal 190 may be disposed between the rotor 120 and the central opening 110 of the stator 105. The seal 190 may include a ring-shape. For example, the seal may be at least partially sleeved around the rotor nozzle 150 and may at least partially contact a surface of the rotor base 155 that faces the central opening 110.

The outer diameter of the seal 190 may be greater than the outer diameter of the rotor nozzle 150 and therefore the seal 190 may be configured to prevent water from leaking between the rotor 120 and the stator 105 during operation of the modular spray assembly 100. For example, as shown in FIG. 4, the crescent-shaped opening remains closed to fluid exit by the seal 190 which is free to slide as a rotor nozzle 150 follows the orbital path. This advantageously reduces the size of rotor 120 thrust face and corresponding friction due to hydraulic pressure. For example, the seal 190 is configured to engage the rotor 120 when the rotor 120 is urged toward the central opening 110. In this way, the hydraulic pressure in the internal cavity 130 can help maintain contact between the rotor 120 and the seal 190 to help to prevent water from leaking between the rotor 120 and the stator 105.

The function of the modular spray assembly 100 will now be discussed with respect to FIGS. 1-4. A flow of fluid, such as water, can enter into the internal cavity 130 formed by the stator 105 through the one or more of inlets 125. For example, the modular spray assembly 100 may be coupled to a spray head such as a showerhead, handheld sprayer, faucet, or another type of water delivery device to receive the flow of water. By using a modular spray assembly with a separate device, there is more design flexibility for the device, such as permitting the use of decorative surface treatments (e.g., electro-plating, etc.) that would otherwise not be permissible with the modular spray assembly itself (e.g., due to material restrictions associated with the use of low friction components in the modular spray assembly, etc.). In some implementations, water may occupy a cavity of a spray head substantially surrounding the stator 105 to allow water to enter into one or more of the plurality of inlets 125 on the modular spray assembly 100. In this way, water can be communicated to the stator 105 through the inlets 125. In other implementations, the stator 105 is fluidly coupled directly to a fluid supply source.

The angle of the inlets 125 can, advantageously, direct water toward the plurality of vanes 146 of the impeller 140 to cause the impeller 140 to rotate about the center axis 210 defined by the first bearing 202. The rotation of the impeller 140 simultaneously causes eccentric rotation of the rotor 120 via the second bearing 204. In other words, rotation of the impeller 140 about the first axis 210 by the first bearing 202 may cause rotation of the rotor 120 eccentrically about the first axis 210 such that the rotor 120 orbits around the first axis 210. This defines the first stage of gear reduction of the modular spray assembly 100.

As the impeller 140 causes the rotor 120 to orbit, the undulating surface of the rotor 120 engages with the corresponding undulating surface of the stator 105, causing the rotor 120 to rotate about its own axis 210. In other words, the engagement between the undulating surfaces of the stator 105 and the rotor 120 causes the rotor 120 to rotate about the second axis 215 defined by the second bearing 204 that is offset from the first axis 210. This defines the second stage of gear reduction of the modular spray assembly 100. In this manner, the hydraulic load of the rotor 120 is directed toward the inner wall 135 of the stator 105, so as to limit the amount of load transmitted to other moving parts in the assembly, thereby improving the useful life of these components and improving overall efficiency of the modular spray assembly 100.

As the rotor base 155 of the rotor 120 rotates, the rotor nozzle 150, integrally connected with the rotor base 155, rotates eccentrically around the first axis 210 and thus causes the one or more nozzles 160 to rotate around the first axis 210. The rotor nozzle 150 also rotates around its own center axis 215 in addition to rotating around the first axis 210. In some implementations, the impeller 140 spins about the center axis 210 of the stator 105 about seven times faster than the rotor nozzle 150 spins about its own center axis 215.

With this configuration, the modular spray assembly 100 converts rotary motion of the impeller 140 to orbital motion of the nozzles 160 as the nozzles 160 follow a hypocycloid path equation. The rotor nozzle 150 path may not have a fixed center, but rather the path may be eccentric due to the central opening 110 of the stator 105 being larger than the rotor nozzle 150 diameter. This allows the nozzles 160 to orbit creating a unique spray pattern that covers a larger area than that of a fixed center (e.g., 2 stage) mechanism. Further, the rotor nozzle 150 motion is orbital because it rotates on its own center axis 215 while it travels on the eccentric path.

The first and second stages of gear reduction, advantageously, provide for a particular gear ratio that produces a particular rotational speed of the nozzles 160 relative to the stator 105 to produce a unique water spray pattern. This unique spray pattern can provide a more effective user experience, as compared to conventional spray heads operating with the same low, or conventional, inlet flow rate. In other words, the modular spray assembly 100 can, advantageously, increase the coverage of a water spray or create an improved massaging effect for a user from a low flow rate water source, as compared to conventional water delivery devices. In addition, by using kinetic motion, the disclosed modular spray assembly 100 can distribute water over a larger area and can help to prevent the numbing sensation that can occur as a result of concentrated water jets impinging on the same area of a user, as is the case with many conventional water delivery devices.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the application as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the apparatus as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments.

Other substitutions, modifications, changes and omissions may also be made in the design, operating conditions and arrangement of the various exemplary embodiments without departing from the scope of the present application. For example, any element disclosed in one embodiment may be incorporated or utilized with any other embodiment disclosed herein.

What is claimed is:

1. A modular spray assembly for a spray head, the modular spray assembly comprising:
a stator comprising an inlet configured to receive a flow of fluid;
a cover coupled to the stator and comprising a first bearing disposed in the stator;
an impeller rotatably coupled to the first bearing, the impeller comprising a second bearing; and
a rotor rotatably coupled to the second bearing, the rotor configured to rotate eccentrically relative to the impeller by the second bearing;
wherein the impeller is configured to rotate responsive to the inlet receiving the flow of fluid.

2. The modular spray assembly of claim 1, further comprising a seal disposed within the stator, wherein the seal is configured to prevent the flow of fluid from leaking through the stator.

3. The modular spray assembly of claim 1, wherein:
the inlet is a first inlet of a plurality of inlets; and
the plurality of inlets are disposed circumferentially about a side of the stator.

4. The modular spray assembly of claim 1, wherein the inlet is disposed at an angle relative to a side of the stator to direct the flow of fluid towards the impeller.

5. The modular spray assembly of claim 1, wherein:
the impeller includes a plurality of vanes disposed circumferentially about the impeller; and
at least one of the plurality of vanes extends at an angle to cause the flow of fluid to flow towards the rotor.

6. The modular spray assembly of claim 1, wherein:
the stator includes an opening at an end of the stator, the opening defining a first diameter;
the rotor includes a nozzle that at least partially extends through the opening of the stator, the nozzle defining a second diameter; and
the first diameter is greater than the second diameter.

7. The modular spray assembly of claim 6, wherein the first diameter is substantially equal to the second diameter plus two times a distance between a first center axis defined by the first bearing and a second center axis defined by the second bearing.

8. The modular spray assembly of claim 1, wherein:
the stator includes an inner undulating surface; and
the rotor includes an outer undulating surface configured to engage with the inner undulating surface of the stator.

9. The modular spray assembly of claim 1, wherein the rotor includes a nozzle that extends at an outward angle away from a center axis of the rotor.

10. A spray head, comprising:
a modular spray assembly, including:
a stator comprising an inlet configured to receive a flow of fluid;
a cover coupled to the stator and comprising a first bearing disposed in the stator;
an impeller rotatably coupled to the first bearing, the impeller comprising a second bearing; and
a rotor rotatably coupled to the second bearing, the rotor configured to rotate eccentrically relative to the impeller by the second bearing;
wherein the impeller is configured to rotate responsive to the inlet receiving the flow of fluid.

11. The spray head of claim 10, further comprising a seal disposed within the stator, wherein the seal is configured to prevent the flow of fluid from leaking through the stator.

12. The spray head of claim 10, wherein:
the inlet is a first inlet of a plurality of inlets; and
the plurality of inlets are disposed circumferentially about a side of the stator.

13. The spray head of claim 10, wherein the inlet is disposed at an angle relative to a side of the stator to direct the flow of fluid towards the impeller.

14. The spray head of claim 10, wherein:
the impeller includes a plurality of vanes disposed circumferentially about the impeller; and
at least one of the plurality of vanes extends at an angle to cause the flow of fluid to flow towards the rotor.

15. The spray head of claim 10, wherein:
the stator includes an opening at an end of the stator, the opening defining a first diameter;
the rotor includes a nozzle that at least partially extends through the opening of the stator, the nozzle defining a second diameter; and
the first diameter is greater than the second diameter.

16. The spray head of claim 15, wherein the first diameter is substantially equal to the second diameter plus two times a distance between a first center axis defined by the first bearing and a second center axis defined by the second bearing.

17. The spray head of claim 10, wherein:
the stator includes an inner undulating surface; and
the rotor includes an outer undulating surface configured to engage with the inner undulating surface of the stator.

18. The spray head of claim 10, wherein the rotor includes a nozzle that extends at an outward angle away from a center axis of the rotor.

19. A modular spray assembly for a spray head, the modular spray assembly comprising:
a body comprising an inner undulating surface, an inlet configured to receive a flow of fluid, and an outlet configured to dispense the flow of fluid;
a cover coupled to the body and comprising a first bearing disposed in the body defining a first axis;
an impeller rotatably coupled to the first bearing, the impeller comprising a second bearing defining a second axis that is offset from the first axis; and
a rotor rotatably coupled to the second bearing and comprising an outer undulating surface, the rotor configured to rotate about the second axis relative to the impeller by the second bearing;
wherein the impeller is configured to rotate about the first axis responsive to the inlet receiving the flow of fluid; and
wherein rotation of the impeller is configured to cause the outer undulating surface of the rotor to engage with the inner undulating surface of the body such that a portion of the rotor orbits relative to the outlet of the body.

20. The modular spray assembly of claim 19, further comprising a seal disposed within the body between the outlet of the body and the rotor, wherein the seal is configured to prevent the flow of fluid from leaking through the body.
